(19) United States
(12) Patent Application Publication
(10) Pub. No.: US 2015/0279233 A1
(43) Pub. Date: Oct. 1, 2015

(54) System and Method for Gamefied Rapid Application Development Environment

(71) Applicant: Patrick H. Vane, Seattle, WA (US)

(72) Inventor: Patrick H. Vane, Seattle, WA (US)

(21) Appl. No.: 14/639,498

(22) Filed: Mar. 5, 2015

Related U.S. Application Data
(63) Continuation-in-part of application No. 14/203,527, filed on Mar. 10, 2014.
(60) Provisional application No. 61/949,144, filed on Mar. 6, 2014.

(51) Int. Cl. G09B 19/00

(52) U.S. Cl. CPC G09B 19/0053

(57) ABSTRACT

A gamification application development system. The system has specialized game development toolbars and a suite of tools. The tools are used to create gamification of continuing education training and are adapted to be used by individuals who are not game designers.

### CROSS REFERENCE TO RELATED APPLICATIONS

This application is a Continuation-in-Part of U.S. patent application Ser. No. 14/203,527 filed Mar. 10, 2014, which claims priority to Provisional Patent application 61/784,592 filed Mar. 14, 2013 and Provisional Patent application 61/824,114 filed May 16, 2013, and to Provisional Patent application 61/949,144 filed Mar. 6, 2014, all of which are herewith incorporated by reference as if fully set forth herein.

### TECHNICAL FIELD

This disclosure relates to game and educational materials development systems.

### BACKGROUND

No game and educational materials development systems are now known that include use of an application development environment with one or more specialized game development toolbars and a suite of tools that can be used to create gamification of Continuing Legal Education (CLE) and other continuing education training

Also, no rapid application development environment is currently known that gives experts in any field simple tools to quickly author or create a game that desirably embodies or captures some or all of the expert's expertise, that is playable by professionals or by non-professionals, and can be used as a teaching and learning device, or just for pure entertainment.

### DISCLOSURE

A Gamefied Rapid Application Development Environment (GRADE) is disclosed. It gives experts in any field simple tools to quickly author or create a game that desirably embodies or captures some or all of the expert's expertise, that is playable by professionals or by non-professionals, and can be used as a teaching and learning device, or just for pure entertainment.

The GRADE includes use of an application development environment with one or more specialized game development toolbars and a suite of tools. These tools can be used to create gamification of Continuing Legal Education (CLE) and other continuing education training and the like, and are advantageously adapted as well to be used by individuals who are not game designers.

An animatic and hyperlinked educational game is disclosed. The game has profuse animated sequences which serve to “gamefy” traditional teaching pedagogy to support and illustrate the teaching points of the game.

### BRIEF DESCRIPTION OF THE DRAWINGS

FIGS. 1-17 are animatic stills from the disclosed GRADE.

FIGS. 18-25 are schematic diagrams of aspects of the disclosed GRADE.

### DETAILED DESCRIPTION

An example game flow goes like this:

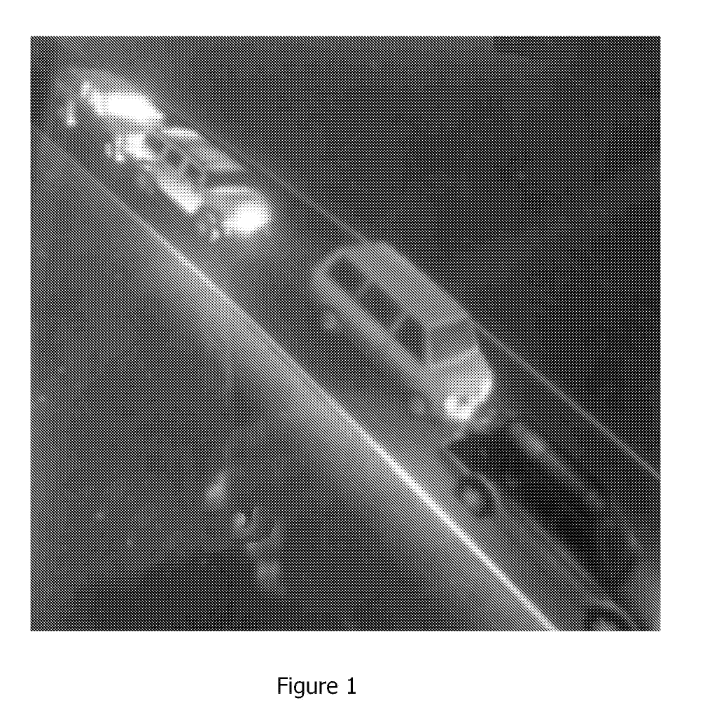

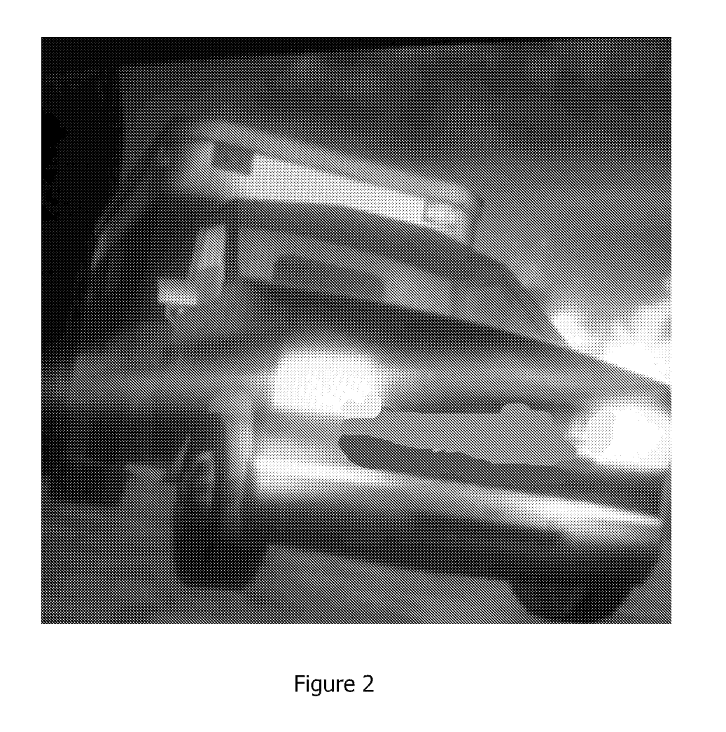

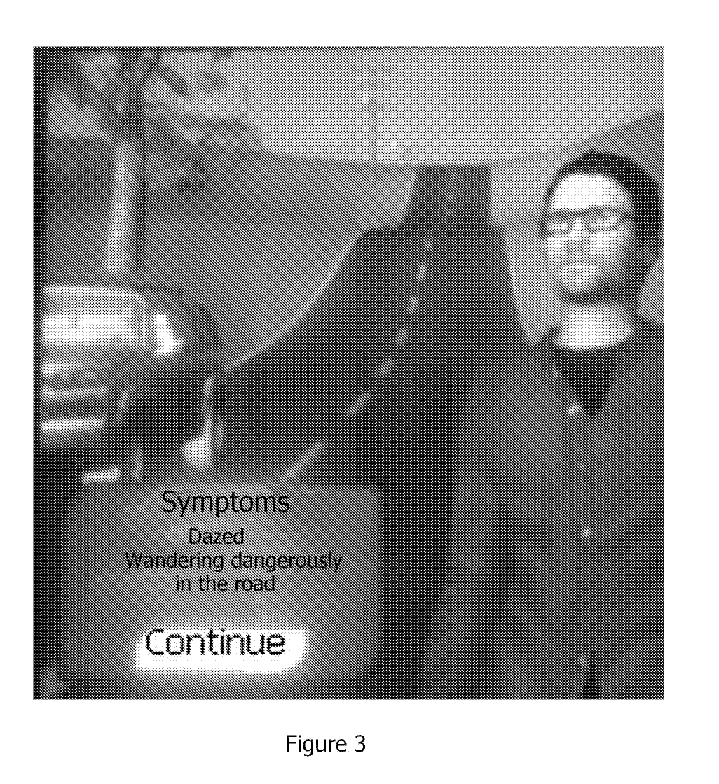

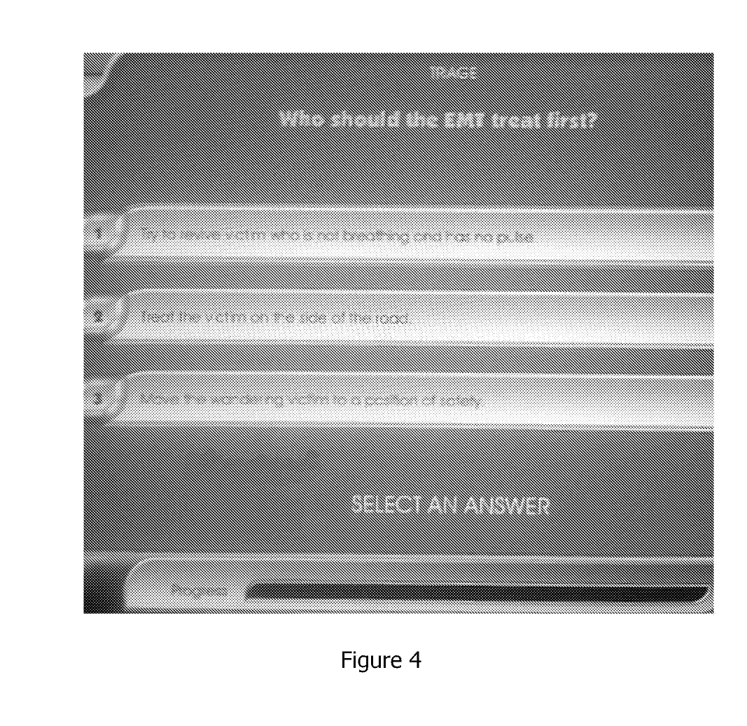

In an animated game scenario, there is modeled a precipitating event (here, a multi-car collision). FIGS. 1 and 2. After the precipitating event, there is a triage stage, also animated and with inserted text windows for questions and choice options. FIGS. 3 and 4. In the example (at the scene of the car accident), there are 3 victims (described) and an EMT triage quest “who to treat first” is provided.

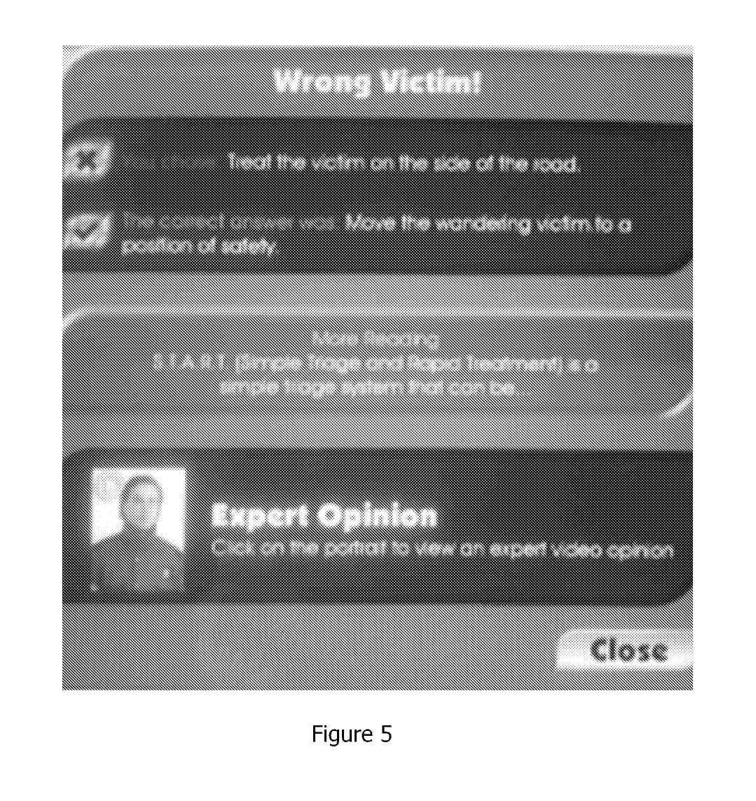

For each response to the quest, the answer is acknowledged as either correct or incorrect, and in either case, right or wrong, there is an option for the viewer to call up (via imbedded hyperlinks) an expert opinion and other educational materials. FIG. 5.

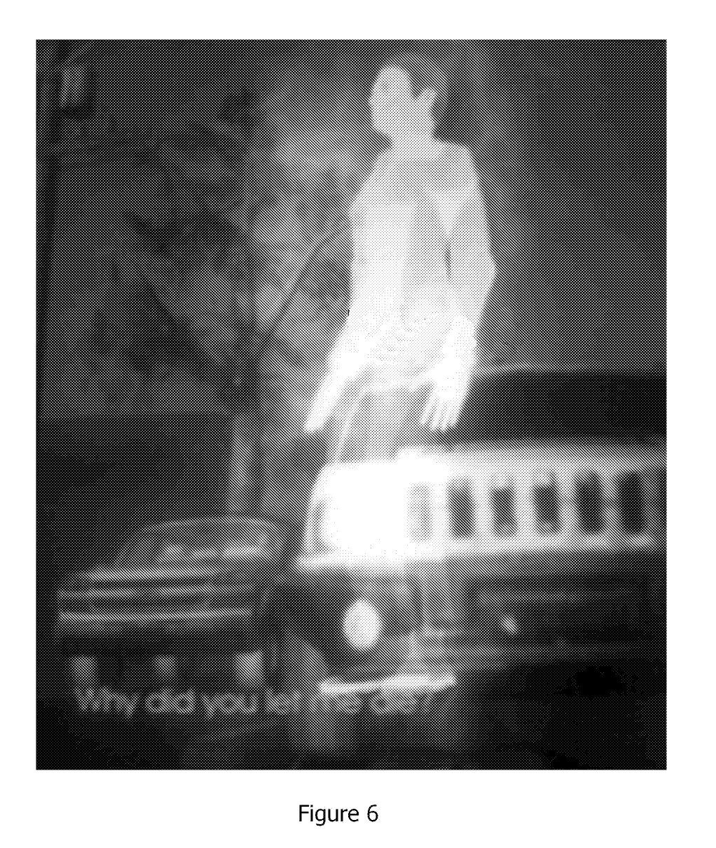

A player's incorrect choices trigger serio-comedic animated “fun/failure” sequences providing humorous emphasis on the shortcomings of the choice. FIG. 6. The “fun/failure” sequences are intentionally spectacular and engaging, designed to elicit proven positive “game play” emotions from the player which drive home a teaching point, even though the player makes an incorrect choice, and which increase the players desire to try again to “get it right”.

The first example of gamefying teaching pedagogy is in the roadside accident (first responder) scene where the player (a first responder) incorrectly fails to chose to make sure the wandering accident victim is escorted to the side of the road, out of danger from passing traffic. In this example, due to an incorrect player choice, the wandering victim is hit by another vehicle and knocked down dead. Spectacularly and unexpectedly, a ghost immediately arises from the body and berates the first responder for failing to make sure he was escorted to the side of the road and out of harms way.

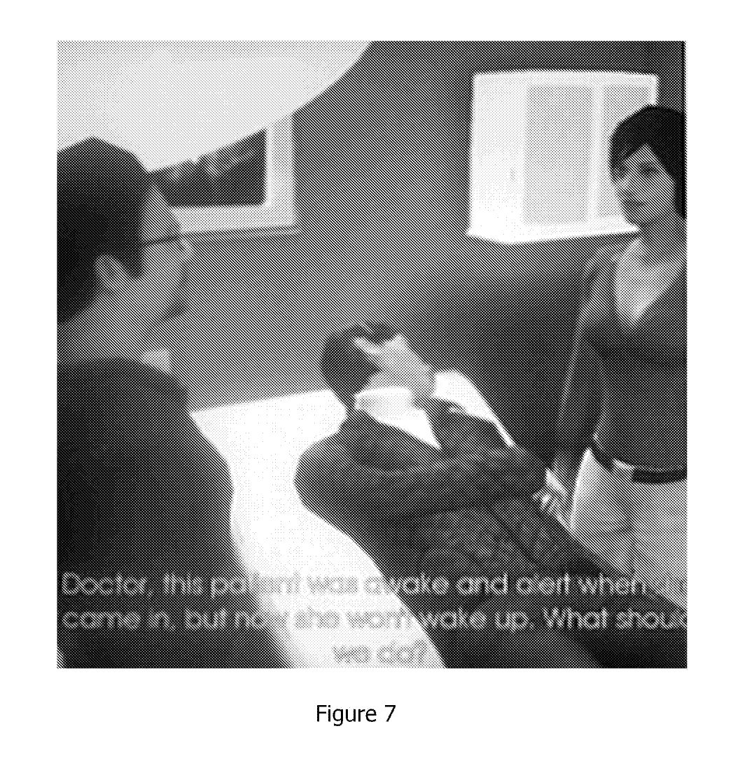

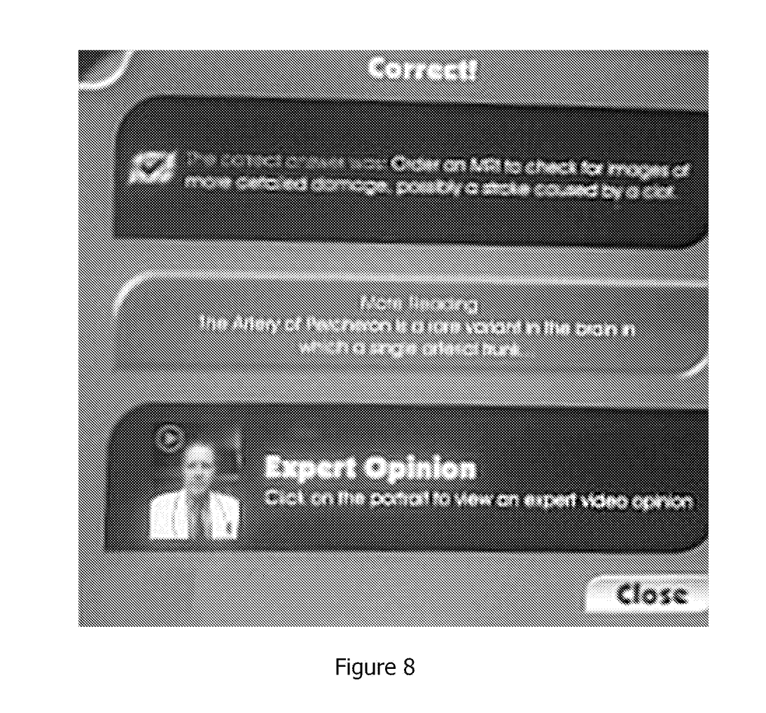

In another example of gamification of teaching pedagogy, at the hospital, application of “spot video lecture” pedagogy is incorporated into a classic medical triage query of “who to treat first”. There are four patients and for each there is a separate query of “what treatment or test to provide first”. FIG. 7. Again, for each response the answer is acknowledged as either correct or incorrect, and in either case, right or wrong, there is an option for the viewer to call up an expert opinion (in the form of a “spot video lecture) and to access additional related educational materials on the “spot”. FIG. 8. The missed diagnosis of a “sleeping victim” (as pointed out in the doctor's spot video on “Percherons Artery”, incorporates utilization of an immediate detailed video into the teaching pedagogy.

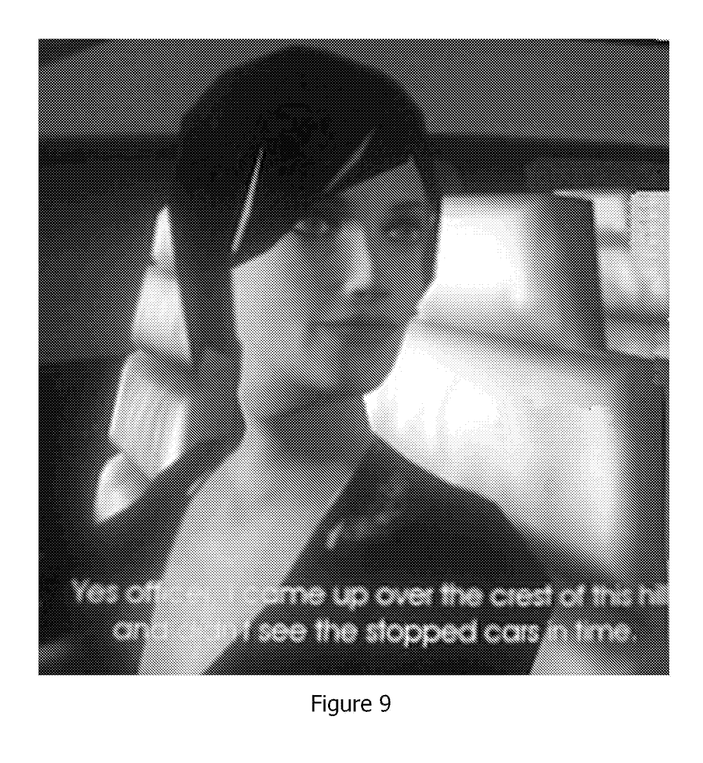

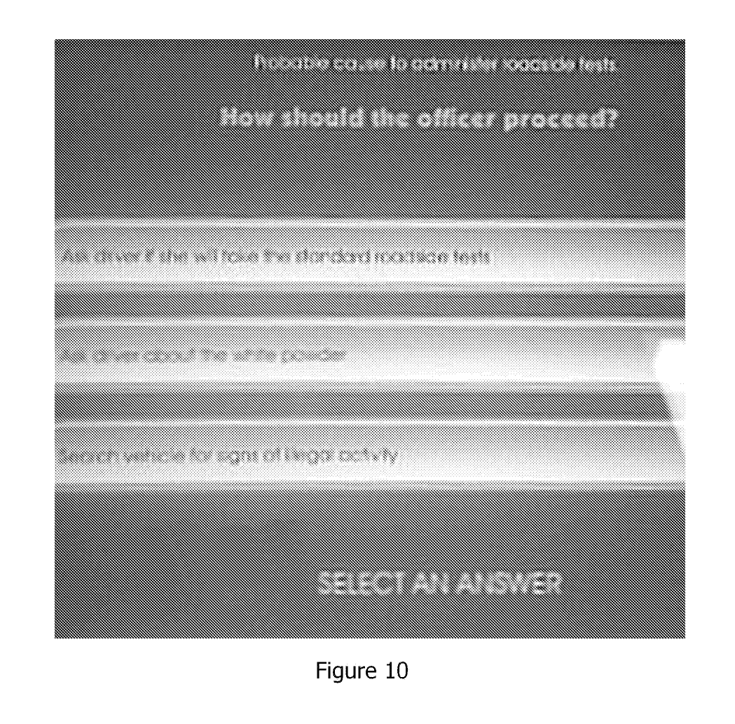

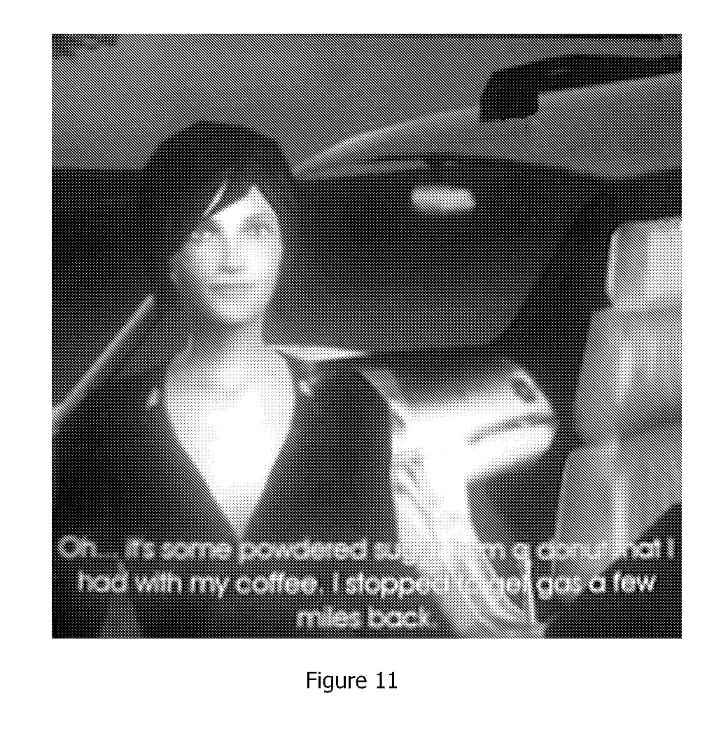

In the example (back at the scene of the accident), gamefication of a law enforcement triage, with legal evidence implications, is presented to the player. FIGS. 9, 10 and 11. A suspect has powder on her sweater (and there is an optional conflict of interest wrinkle not fully presented where the officer is strongly attracted to the beautiful suspect). The quest presented is “how best to proceed in the absence of probable cause” or “how to perfect probable cause”.

Again, for each response the answer is acknowledged as either correct or incorrect, and in either case there is an option for the viewer to call up an expert opinion and other educational materials.

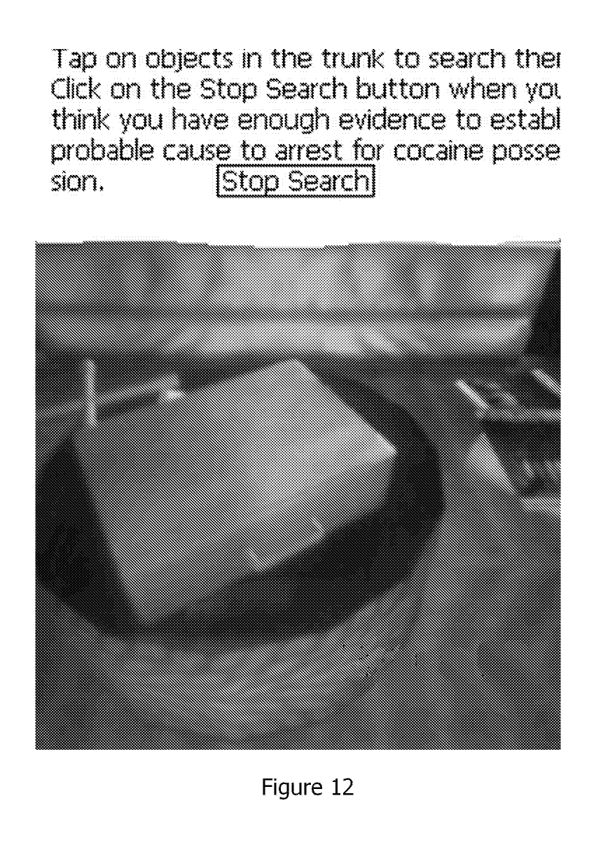

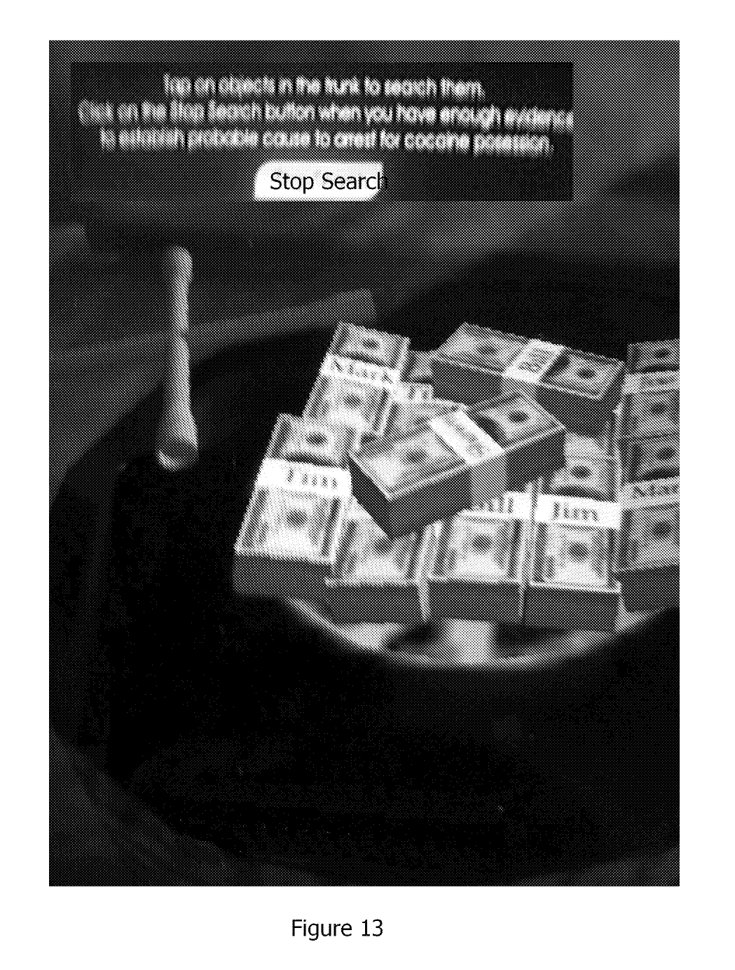

In this particular example, there is the incorporation of an option for an extended search, a game-within-a-game. The search game is played out in an animation of a trunk full of objects, where clicking on an object removes it from view and reveals what is beneath it, until the player determines probable cause is deemed established. FIGS. 12 and 13.

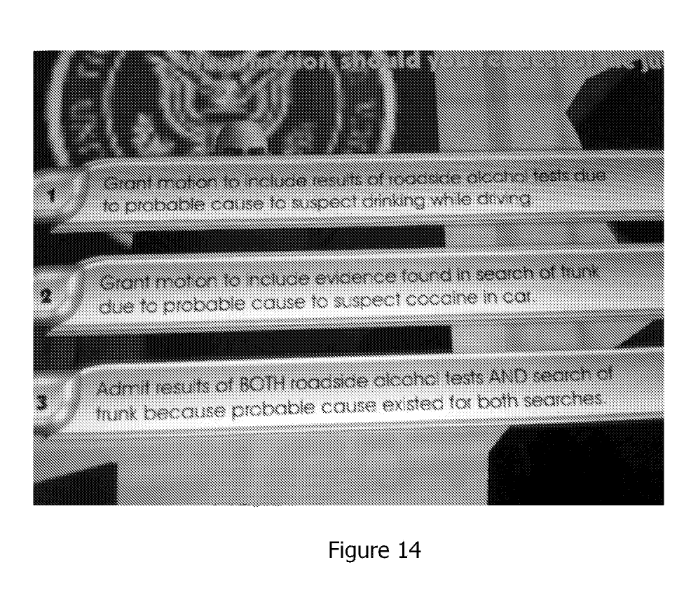

This example then segues to a courtroom for a legal triage and query sequence about what is the proper legal evidentiary motion to bring in view of the evidence obtained. In FIG. 14 the answer is acknowledged as either correct or incorrect, and in either case there is an option for the viewer to call up an expert opinion and other educational materials.

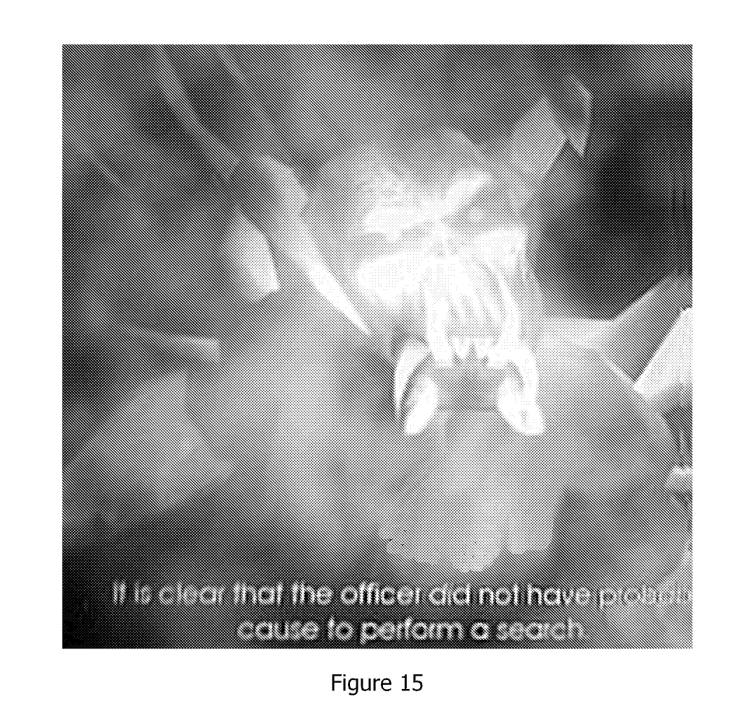

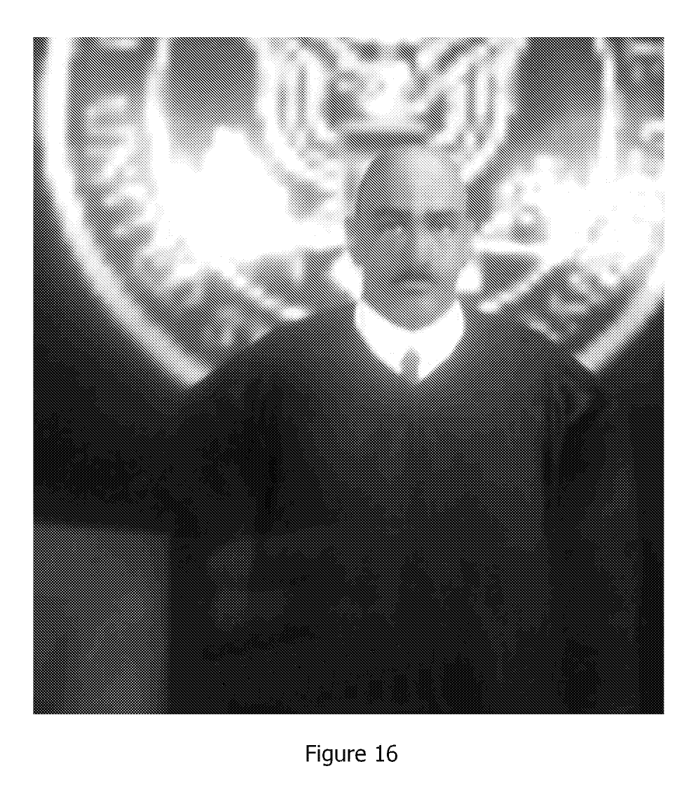

Here an incorrect choice triggers another serio-comedic, “fun/failure” animated sequence providing emphasis on the teaching point of the exercise and the shortcomings of the choice that was made. FIGS. 15 and 16.

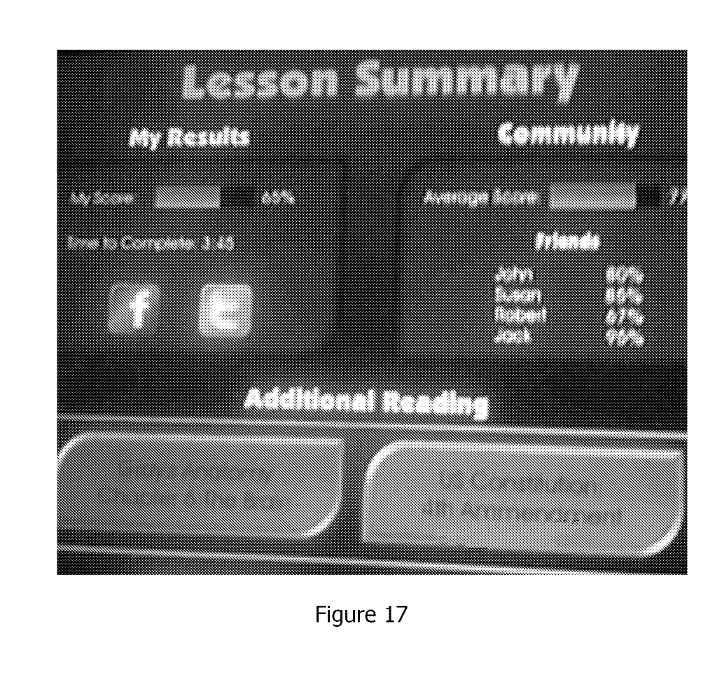

At the game end, viewer/student/player choices are tabulated and a “community” comparison of the scores of others in the comparable community is provided so the player can see how well they played in comparison to the universe of other gamers worldwide. Links to several additional sources of educational materials are also provided. FIG. 17.

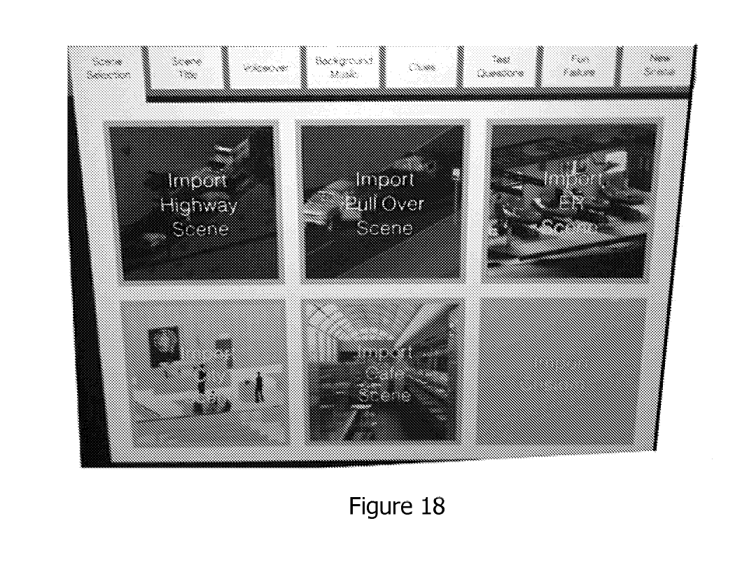

FIG. 18 depicts a tool bar atop a drop down of the choices the game creator has for selecting the first game component in game creation . . . . “Opening Scene”. From here the creator selects a standard “opening scene” or imports an opening scene of their own creation. If a creator imports a scene they created, that scene becomes a part of a database of scenes which a subsequent creator can access in order to chose a scene without having to create their own. In this manner over time a large database of available “scenes” can be accessed and created by subsequent game creators, thus facilitating the availability of a growing (and searchable) database of “scenes” for easy scene creation.

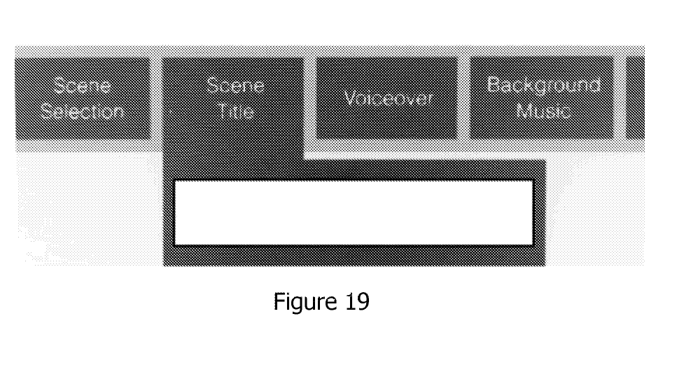

FIG. 19 is the second menu choice drop down in the game creation sequence. It is provided to allow a means for the creator of the game to “title” the learning session. A block appears which allows the creator to type a customizable “title” for the learning session.

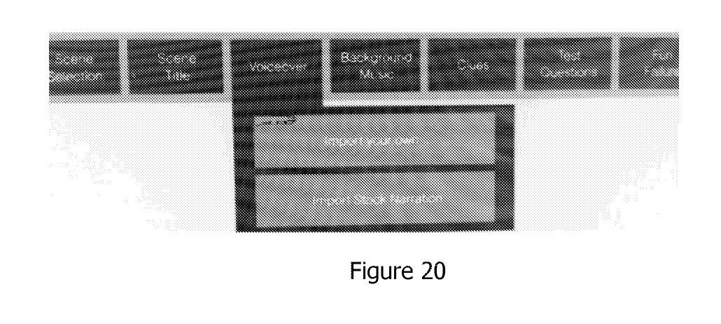

FIG. 20 is the “VoiceOver” tab. This third tab allows the creator to create a “VoiceOver” audio track which allows the creator to “state the quest”, or the goal of the game. First stating and recording the quest in his or her own voice by laying down an audio track (using their own recording device (for example, an iPhone), the game creator can create an audio track which states the “quest”, and then is able to enhance the audio track by applying an accent (french?, Italian?) or perhaps converting the audio tract to another language.

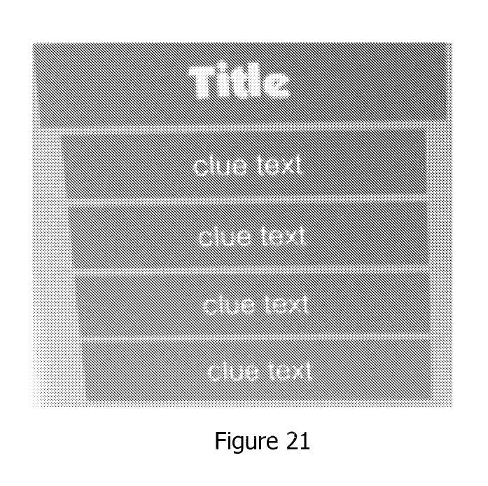

FIG. 21 is the fourth tab, which allows the creator to select background music from a list of musical selections which are resident in the database of existing music library, or the creator can select the option to import their own music created by themselves.

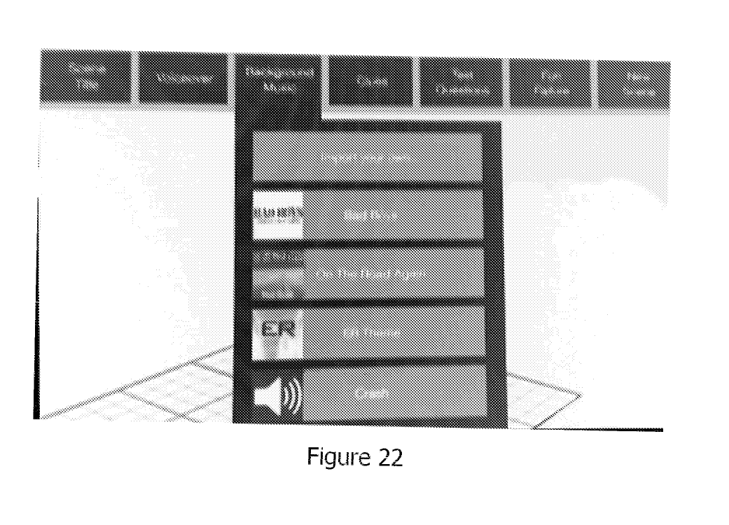

FIG. 22 is fifth tab, which allows the game creator to pull up a “clues” field which allows the creator to populate the “clue” fields with one or more clues which in turn allow the person playing the game to solve the “quest”. These “clue” boxes can be applied as many times as necessary to as many scenes as necessary to complete the game.

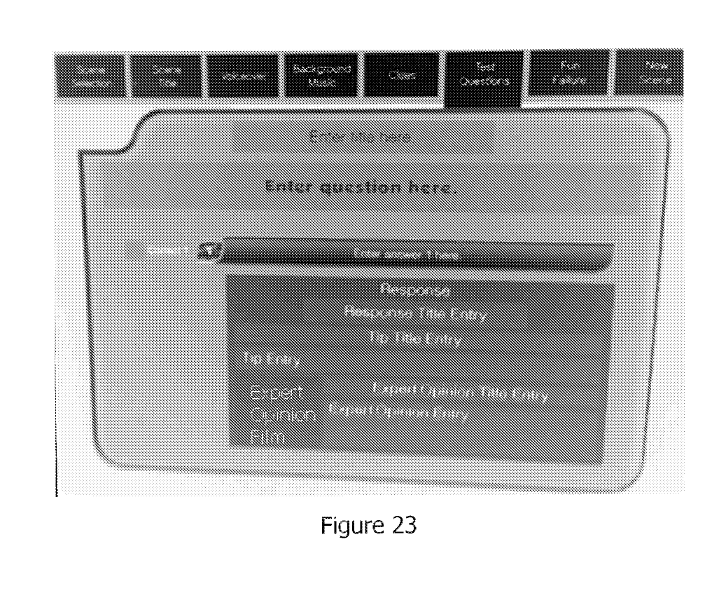

FIG. 23 is a tab that allows the creator to compose questions which can be placed at any point during the game. This screen allows for creation of the question, with several possible wrong answers and the one correct answer. This screen also allows for the creation of one or more “tips”, as well as the opportunity to play an imbedded video which delivers an “instant mini-lecture” on the question in case the game player selects the wrong answer. This “instant lecture” is a unique component to the pedagogical learning process online There is also an “expert opinion” text section which allows for a text box of expert opinion.

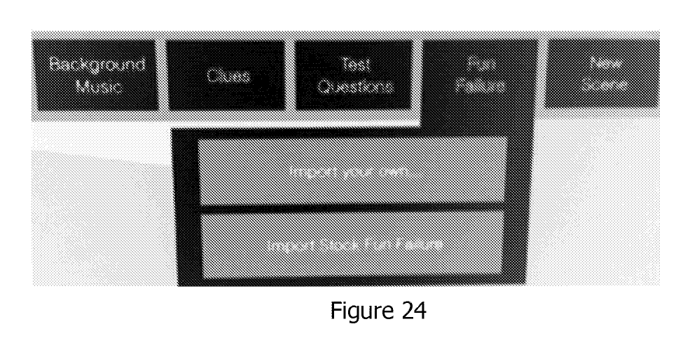

FIG. 24 is the tab that allows the game creator to compose a “fun failure sequence”, which is a pedagogical tool designed to make the results of failure (getting the test question wrong) so outrageously funny, that the player easily remembers the outcome and “never makes that mistake again.” Fun failure is a key learning device unique to online training

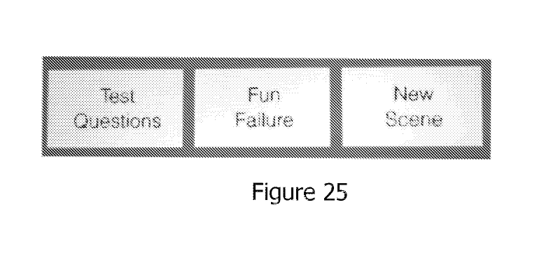

FIG. 25 is the tab that recycles the creator back to the next step in the game creation process which is the creation of the next scene. This begins the “scene creation” process for the next scene and is repeated until all of the scenes are completed for the game.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A gamification application development system having one or more specialized game development toolbars and a suite of tools, the tools used to create gamification of continuing education training, the tools adapted to be used by individuals who are not game designers.

2. An educational game having a plurality of animated and hyperlinked sequences serving to “gamefy” traditional teaching pedagogy to support and illustrate the teaching points of the game.
